(19) United States
(12) Patent Application Publication
(10) Pub. No.: US 2009/0086966 A1
(43) Pub. Date: Apr. 2, 2009

(54) REPRODUCTION APPARATUS, REPRODUCTION METHOD AND INFORMATION RECORDING MEDIUM

(75) Inventors: Kosuke Haruki, Ome-shi (JP); Toru Kambayashi, Chigasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/237,055

(22) Filed: Sep. 24, 2008

(30) Foreign Application Priority Data
Sep. 28, 2007 (JP) 2007-256619
Feb. 27, 2008 (JP) 2008-046181

(51) Int. Cl. H04L 9/06

(52) U.S. Cl. 380/44

(57) ABSTRACT

According to one embodiment, an information storage medium comprises a content encrypted by a content encryption key; a content encryption key file encrypted by a first encryption key or third encryption key; an encryption key block from which a third encryption key prime providing a source of the first encryption key or third encryption key by being processed by using a second encryption key of a player; and a program configured to make the player calculate the third encryption key from the third encryption key prime. The content encryption key file comprises a flag indicating whether the key file is encrypted by the third encryption key or first encryption key.

### CROSS-REFERENCE TO RELATED APPLICATIONS

This application is based upon and claims the benefit of priority from Japanese Patent Applications No. 2007-256619, filed Sep. 28, 2007 and No. 2008-046181, filed Feb. 27, 2008 and, the entire contents of which are incorporated herein by reference.

### BACKGROUND

1. Field

One embodiment of the present invention relates to an information recording medium for storing an encrypted digital content, and a reproduction apparatus and a reproduction method for the information recording medium.

2. Description of the Related Art

With the recent development of the digital compression coding technique for a moving image, a reproduction apparatus or reproduction software (both of which will be hereinafter collectively referred to simply as a player) capable of handling a high-resolution image of the High-Definition (HD) standard has been under development.

This player uses an information recording medium such as a High-Definition Digital Versatile Disc (HD DVD). The use of a storage medium such as HD DVD makes it possible to implement HD video data and high-quality surround audio data in a single storage medium.

The encryption method such as Content Scramble System (CSS) is conventional known as a technique for protecting the digital content stored in the storage medium from being illegally copied.

Japanese Patent No. 3162046 discloses a digital content stream such as the video data embedded with copy control information. The copy control information is used for realizing a copy protection function to limit the copy of the digital content such as the video data.

Also, a new technique for protecting various kinds of digital content including the HD content has recently been proposed.

According to this content protection specification, a content protection module of the player generates a first encryption key by processing an encryption key block on the storage medium using a second encryption key set of the player. The content protection module decrypts a content encryption key file on the storage medium using the first encryption key, so that a content encryption key for decrypting the digital content on the storage medium is acquired from the content encryption key file.

The content data on the storage medium including the video, still image, XML file and script are decrypted using the content encryption key recorded in the content encryption key file. The content encryption key is used also for checking the legitimacy of the content data.

The encryption key block contains the information for revoking (invalidating) a player or a player group. The correct first encryption key cannot be acquired even in the case where the encryption key block on the storage medium is processed by the revoked player. Thus, the revoked player is prevented from reproducing the content data on the particular storage medium.

In the case where a given player is hacked and the first encryption key extracted from the encryption key block on the storage medium is illegally retrieved from the particular player, however, all the reproducible video titles on the player are liable to be illegally copied.

The hacked player can be revoked by updating the encryption key block as described above. The encryption key block updated to revoke the hacked player is issued from an organization coordinating the content protection. Before the spread of the new video title storing the updated encryption key block, however, considerable time is taken. This is due to the requirement to follow the steps of (i) acquiring the updated encryption key block, (ii) fabricating the disk using the acquired encryption key block, and (iii) marketing the new disk.

The video title marketed before the encryption key block is updated is liable to be illegally copied.

As auxiliary means, therefore, the studio (content provider) releasing the video title desirably realizes a new function capable of revoking the player by itself. In other words, even during the period before the encryption key block is updated, it is necessary to realize the new control function to flexibly permit or prohibit the reproduction of the video title. Even in such a case, the leak of the first encryption key or other data generated while the first encryption key is extracted is required to be prevented.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing the configuration of a reproduction apparatus according to an embodiment of the invention.

FIG. 2 is an exemplary diagram showing an example of the relation between a player group and a third encryption key prime.

FIG. 3 is an exemplary diagram showing an example of the interface between an arithmetic operation processing unit of a content protection module and a script included in the reproduction apparatus according to the embodiment.

FIG. 4 is an exemplary diagram showing an example of description of a class provided by the content protection module included in the reproduction apparatus according to the embodiment.

FIG. 5 is an exemplary diagram showing an example of the script used by the reproduction apparatus according to the embodiment.

FIG. 6 is an exemplary diagram showing another example of the script used by the reproduction apparatus according to the embodiment.

FIG. 7 is an exemplary flowchart showing the steps of the process executed by the script used in the reproduction apparatus according to the embodiment.

FIG. 8 is an exemplary flowchart showing the steps of the process executed by the content protection module included in the reproduction apparatus according to the embodiment.

FIG. 9 is an exemplary flowchart showing a starting sequence for the reproduction apparatus according to the same embodiment.

FIG. 10 is an exemplary diagram showing an example of a content encryption key file stored in a disk reproduced by the reproduction apparatus according to the same embodiment.

### DETAILED DESCRIPTION

Various embodiments according to the invention will be described hereinafter with reference to the accompanying drawings. In general, according to one embodiment of the invention, an information storage medium comprises a content encrypted by a content encryption key; a content encryption key file encrypted by one of a first encryption key and third encryption key; an encryption key block from which a third encryption key prime providing a source of generating the first encryption key or third encryption key by being processed by using a second encryption key of a reproduction apparatus; and a program configured to make the reproduction apparatus calculate the third encryption key from the third encryption key prime, wherein the content encryption key file comprises a flag indicating whether the content encryption key file is encrypted by the third encryption key or by the first encryption key.

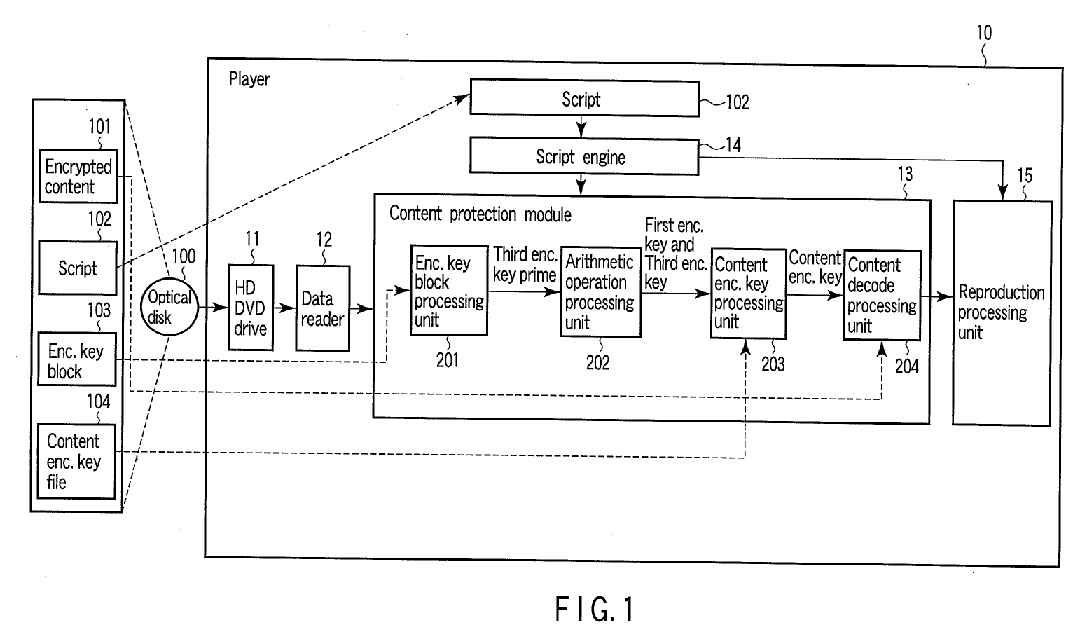

An example of the configuration of the reproduction apparatus according to an embodiment of the invention is shown in FIG. 1. This reproduction apparatus is a player for reproducing the digital content configured of a data stream such as video data (audio-visual data). This reproduction apparatus is implemented as an HD DVD player 10 for reproducing the digital content such as a video title stored in a storage medium like the HD DVD. The HD DVD player 10 can reproduce not only the digital content stored in an optical disk medium 100 serving as a storage medium but also the digital content downloaded from a network server through a network such as the Internet.

The HD DVD player 10, as shown in FIG. 1, includes an HD DVD drive 11, a data reader 12, a content protection module (encryption processing module) 13, a script engine 14, and a reproduction processing unit 15.

The optical disk medium (HD DVD medium) 100 driven by the HD DVD drive 11 has stored therein an encrypted digital content 101, a script 102, an encryption key block 103, and a content encryption key file 104.

The digital content 101 is an audio-visual content such as a movie or an animation. The audio-visual content is a stream of video and audio data multiplexed with each other. The audio content configured of only the audio data may of course be stored in the optical disk medium.

The digital content 101 includes a video object VOB such as an enhanced video object EVOB (primary enhanced video object P-EVOB or secondary enhanced video object S-EVOB) specified by the HD DVD standard. The video object VOB is configured of plural video object units VOBU (the primary enhanced video object units P-EVOBU and the secondary enhanced video objects S-EVOBU specified by the HD DVD standard). The video object unit VOBU is a data stream corresponding to a predetermined reproduction time and includes compression-coded video data and compression-coded audio data. The digital content is encrypted in video object units VOBU such as P-EVOBU or S-EVOBU.

The script 102 is one of plural scripts stored in the optical disk medium 100. The script is one of the languages for controlling the reproduction of various data widely used for the web such as JPEG images, PNG images, MNG animation, WAVE audio or True Type fonts employed by the advance content under the HD DVD standard. Many of these scripts are programs describing the procedure for reproducing the digital content 101 interactively. According to this embodiment, the script 102 which is a program for controlling the process of extracting the first encryption key from the encryption key block 103 is stored in the optical disk medium 100.

This embodiment proposes a process in which the content provider can invalidate the device on its own in order to prevent a trouble of the conventional encryption key block process, i.e., a disk released from being illegally copied before the encryption key block is updated by the organization coordinating the content protection. Normally, the first encryption key is extracted by the encryption key block processing of the second encryption key. In the case of the second encryption key of a certain class (a certain group of the second encryption keys), however, the first encryption key is not extracted directly, but the first encryption key prime is extracted. With the action of the key conversion function stored in the lead-in area of the disk on the first encryption key prime, the first encryption key is extracted. The content encryption key, on the other hand, is encrypted by the third encryption key as well as by the first encryption key. The third encryption key is calculated by a arithmetic operation process (software key conversion function) executed on the third encryption key prime which is the data acquired by processing the encryption key block 103 with the second encryption key set stored in the player 10. This arithmetic operation process is provided by the script 102. The encryption key block is processed by the second encryption key set thereby to calculate the first encryption key prime, and then the first encryption key is generated by the key conversion function process. This conventional encryption key block process is called a legacy encryption key block process. On the other hand, the process of generating the third encryption key by executing the software key conversion function process on the third encryption key prime obtained by the encryption key block process is called a new encryption key block process. An encryption key block processing unit 201 according to this embodiment can execute both the new encryption key block process and the legacy encryption key block process. In the case where the legacy encryption key block process is executed, the first encryption key is generated and supplied to a content encryption key processing unit 203.

The second encryption key set is a group of confidential keys assigned to each player and varied depending on a player or a player group. The players fabricated by the same maker, for example, belong to the same player group.

The second encryption key set is stored in advance in the player 10 at the time of fabrication of the player 10. The second encryption key set stored in the player 10 is used to calculate the first encryption key prime/third encryption key prime providing the data required to extract the first encryption key/third encryption key by processing the encryption key block 103. The first encryption key prime/third encryption key prime is varied depending on a player or a player group. Specifically, the first encryption key prime/third encryption key prime is data unique to the player or the player group, and the value obtained by an arithmetic operation performed on the particular data (the first encryption key prime/third encryption key prime) provides the first encryption key/third encryption key to decrypt the content encryption key file 104 on the optical disk medium 100. In other words, assuming that the first encryption key prime/third encryption key prime is Amp and the first encryption key/third encryption key is Am, the relation holds that

Am=f(Amp)

where f is an arithmetic operation (also called simply as the operation).

Plural different operation processing instructions corresponding to plural players or plural player groups can be described beforehand in the script 102. In this case, the script 102 discriminates the player 10 or a player group including the player 10, and from the plural operation processing instructions, selects the one corresponding to the player 10 or a player group including the player 10, and sends the operation processing instruction thus selected to the content protection module 13. Scripts of different patterns are prepared for different makers of the player, and the operation process is executed by the script on the different third encryption keys generated by the encryption key block process for the different makers thereby to generate a common third encryption key shared by the different makers. The script 102 controls also the graphics of the graphic plane and the reproduction sequence by events such as the user input event and the player reproduction event.

The encryption key block 103 is a data block for providing the access to the aforementioned third encryption key prime unique to the player or the player group. Specifically, the encryption key block 103 is a data block generated by the organization coordinating the content protection to permit each player to calculate the third encryption key prime unique to the player or the player group including the player using the second encryption key set thereof.

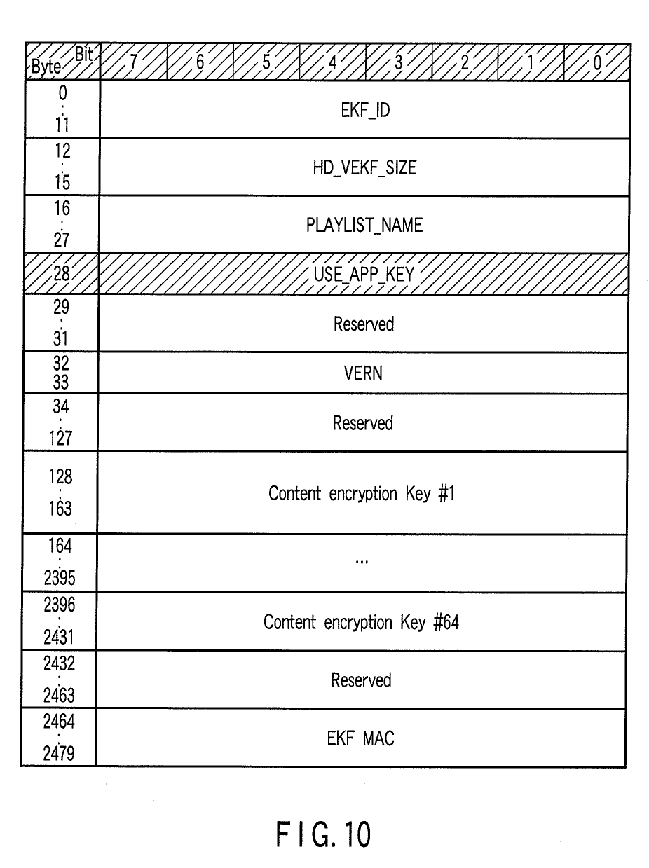

The content encryption key file 104 includes several content encryption keys and is encrypted. The content 101 is encrypted by the content encryption key. This content encryption key is used for decrypting the content 101. The content encryption key file 104 is prepared for each playlist. Each content encryption key file is prohibited from being accessed by two or more playlists. The file name VPLIST%%% of the playlist is converted to the file name VTKF%%% of the content encryption key file, and the file name APLIST%%% of the playlist to the file name ATKF%%% of the content encryption key file. The symbol %%% is one of the values 000 to 999. An example of the content encryption key file is shown in FIG. 10.

The 12-byte EKF_ID at byte positions 0 to 11 is the identifier of the content encryption key file. The four-byte HD_VEKF_SIZE at byte positions 12 to 15 indicates the last address (fixed value of 2480) of the content encryption key file. The 12-byte PLAYLIST_NAME at byte positions 16 to 27 is the name of the playlist associated with the content encryption key.

At byte position 28, USE_APP_KEY indicates whether the content encryption key is encrypted by the first encryption key (generated by the legacy encryption key block process) or by the third encryption key (generated by the new encryption key block process). In the case where this value is “1”, it indicates that the content encryption key is encrypted by the third encryption key, while in the case where the value is “0”, on the other hand, it indicates that the content encryption key is encrypted by the first encryption key.

The two-byte VERN at byte positions 32 to 33 indicates the version number of the content encryption key file. At byte positions 128 to 2431, 64 content encryption key entries of 36 bytes are stored. The actual content encryption key is 16 bytes. The 16-byte EKF MAC at byte positions 2464 to 2479 stores the CMAC value of the data at byte positions 0 to 2463. The key for calculation of the CMAC value is a volume unique key.

The data reader 12 accesses the HD DVD drive 11 and reads the data (for example, the digital content 101, the script 102, the encryption key block 103, the content encryption key file 104, etc.) stored in the optical disk medium 100.

The content protection module 13 is a processing module for realizing the copyright protection function specified by the organization coordinating the content protection and interposed between the data reader 12 and the reproduction processing unit 15. The content protection module 13 has a tamper-resistant construction according to the technique such as tamper-resistant software (TRS), etc. and executes the process for decrypting the content.

The content protection module 13 includes an encryption key block processing unit 201, an operation processing unit 202, a content encryption key processing unit 203, and a content decrypt processing unit 204.

In the encryption key block processing unit 201, the encryption key block 103 stored in the optical disk medium 100 is processed by the second encryption key set of the player 10 thereby to calculate the first encryption key prime/third encryption key prime constituting the data unique to the player 10 or a player group including the player 10.

The operation processing unit 202 provides the script 102 with the interface for operating the first encryption key prime/third encryption key prime stored in the content protection module 13. In this case, the operation processing unit 202 executes the arithmetic operation on the first encryption key prime/third encryption key prime in accordance with the operation processing instruction sent to the first encryption key prime/third encryption key prime through the script engine 14 from the script 102 without delivering the value of the first encryption key prime/third encryption key prime stored in the content protection module 13 to the script 102 and the script engine 14. This operation is executed while the value of and the operation result on the first encryption key prime/third encryption key prime are concealed from the script 102 and the script engine 14. In this way, the operation processing instruction sent out from the script 102 is received by the operation processing unit 202, and the actual arithmetic operation for the first encryption key prime/third encryption key prime is performed by the operation processing unit 202 by itself. Thus, the value of and the operation result on the first encryption key prime/third encryption key prime can be concealed.

For example, the operation processing unit 202 has several functions for calculating the first encryption key prime/third encryption key prime, and the script 102, through these functions, designates the content of calculation for the first encryption key prime/third encryption key prime. The script 102 cannot operate the first encryption key prime/third encryption key prime directly, and the operation on the first encryption key prime/third encryption key prime can be executed only through the function stored in the operation processing unit 202.

As long as the correct operation processing instruction is transmitted from the script 102 to the operation processing unit 202, the operation processing unit 202 can execute the correct operation process for the first encryption key prime/third encryption key prime thereby to calculate the correct first encryption key prime or the correct third encryption key. In the case where the correct operation processing instruction is not transmitted from the script 102 to the operation processing unit 202, on the other hand, the operation processing unit 202 cannot calculate the correct first encryption key prime or the correct third encryption key. The script 102 associated with the content 101 can be provided by the studio on its own. Simply by changing the content of the script 102, therefore, the studio can flexibly perform the control operation to permit or prohibit the reproduction of the content 101. Further, the operation processing unit 202 is configured not to deliver the value of the first encryption key prime/third encryption key prime stored in the content protection module 13 to the script 102 and the script engine 14 but to execute the arithmetic operation on the first encryption key prime/third encryption key prime in accordance with the operation processing instruction sent from the script 102. Therefore, the value of and the result of the arithmetic operation on the first encryption key prime/third encryption key prime can be concealed from the script 102 and the script engine 14. Thus, the arithmetic operation on the first encryption key prime/third encryption key prime can be executed safely.

The content encryption key processing unit 203 uses the result of the operation on the first encryption key prime/third encryption key prime by the operation processing unit 202 as a first encryption key/third encryption key thereby to execute the process for decrypting the content encryption key file 104. Once the correct first encryption key/third encryption key is calculated by the operation processing unit 202, the content encryption key processing unit 203 can correctly decrypt the content encryption key file 104 using the particular first encryption key/third encryption key, with the result that the content encryption key for decrypting the content 101 can be acquired from the content encryption key file 104.

The content decrypt processing unit 204 decrypts the content 101 with the content encryption key acquired by the content encryption key processing unit 203.

The reproduction processing unit 15 executes the reproduction process for reproducing the content 101 decrypted by the content decrypt processing unit 204. In the reproduction process, the video data and the audio data contained in each video object unit VOBU such as P-EVOBU or S-EVOBU is decrypted.

The script engine 14 is a program execution module for executing the script 102. The script engine 14 functions as a program execution environment such as an interpreter.

Next, an example of the relation between the first encryption key prime/third encryption key prime and the first encryption key/third encryption key will be specifically explained.

The encryption key block 103 is prepared in such a manner that the result of processing the encryption key block 103 by the content protection module 13 of the player 10, on which the operation f is executed, constitutes the first encryption key/third encryption key. The data extracted by the encryption key block process by the content protection module 13 is the first encryption key prime/third encryption key prime described above. As explained above, assuming that Amp indicates the first encryption key prime/third encryption key prime and Am indicates the first encryption key/third encryption key, then the relation Am=f(Amp) holds.

The content of the operation f varies depending on the player. A player group formed of players fabricated by a maker, for example, outputs the same first encryption key prime/third encryption key prime by processing the first encryption key block 103 on the disk, while another player group formed of players fabricated by another maker, on the other hand, processes the same encryption key block 103 and outputs a first encryption key prime/third encryption key prime different from the aforementioned first encryption key prime/third encryption key prime. Each player is allotted a numerical value (ID information) called the node ID.

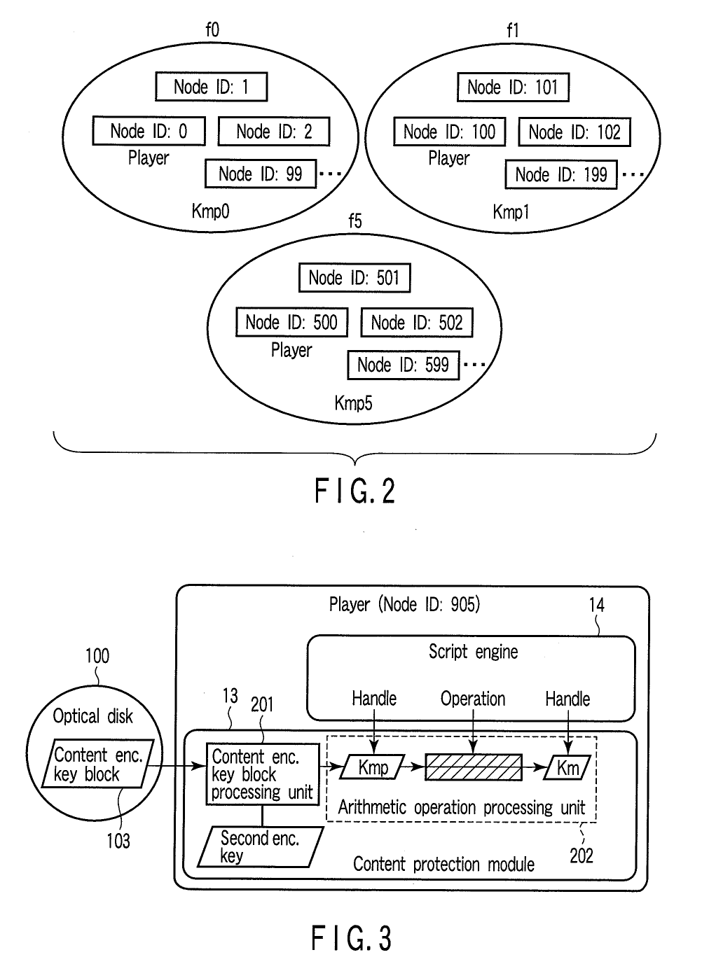

Assume, as shown in FIG. 2, that the first encryption key prime/third encryption key prime corresponding to a given group of node IDs is designated as Amp0, the first encryption key prime/third encryption key prime corresponding to another group of node IDs as Amp1, the first encryption key prime/third encryption key prime corresponding to still another group of node IDs as Amp2, and so forth.

There exist the operations f0, f1, f2, and so forth corresponding to Amp0, Amp1, Amp2, and so forth, respectively, and the relation holds that f0(Amp0)=f1(Amp1)=f2(Amp2)= . . . =Am.

Specifically, in FIG. 2, each of the players of Node ID=0, Node ID=1, Node ID=2, . . . , Node ID=99 belongs to the same player group. The first encryption key prime/third encryption key prime obtained by each player of this player group processing the encryption key block 103 using the second encryption key set unique to the particular player is Amp0. The operation f corresponding to Amp0 is f0.

The players of Node ID=100, Node ID=101, Node ID=102, . . . , Node ID=199 belong to another player group. The first encryption key prime/third encryption key prime obtained by each player of this player group processing the encryption key block 103 using the second encryption key set unique to the particular player is Amp1. The operation f corresponding to Amp1 is f1.

The players of Node ID=500, Node ID=501, Node ID=502, . . . , Node ID=599 belong to still another group, respectively. The third encryption key prime obtained by each player of this player group processing the encryption key block 103 using the second encryption key set unique to the particular player of the particular player group is Amp5. The operation f corresponding to Amp5 is f5.

The instruction for execution of the operations f1, f2, . . . , f5 is given from the script 102 to the content protection module 13.

Next, with reference to FIG. 3, a specific example of the interface between the script 102 and the operation processing unit 202 of the content protection module 13 will be explained.

The data including the first encryption key prime/third encryption key prime and the first encryption key/third encryption key are stored in the content protection module 13. The content protection module 13 has a tamper-resistant construction, and therefore, neither the data in the content protection module 13 can be read from outside thereof nor the content of the process in the content protection module 13 can be known from outside thereof.

The script engine 14, on the other hand, has no tamper-resistant construction. To secure safety, therefore, it is not desirable that the script 102 executed by the script engine 14 reads the value of the first encryption key prime/third encryption key prime or the value of the first encryption key/third encryption key from the content protection module 13. Specifically, if the script 102 reads the value of the first encryption key/third encryption key, a hacker may come to know the value of the first encryption key/third encryption key for lack of the tamper-resistant characteristic of the script engine 14.

The script 102, however, is required to operate the first encryption key prime/third encryption key prime and the first encryption key/third encryption key. Specifically, the script 102 is required to perform such operation as adding a certain numerical value to or shifting the bit number on the first encryption key prime/third encryption key prime in order to extract the first encryption key/third encryption key. This series of operations makes up the operation f described above. For this purpose, the operation processing unit 202 in the content protection module 13 has a handle for the script 102 to operate the first encryption key prime/third encryption key prime. This handle is an interface permitting the script 102 to instruct the content protection module 13 to execute the arithmetic operation on the first encryption key prime/third encryption key prime stored in the particular content protection module 13. This handle can be realized by a function group for performing the arithmetic operation on the first encryption key prime/third encryption key prime and the function of notifying the content protection module 13 that the result of operation on the first encryption key prime/third encryption key prime is the first encryption key/third encryption key. This handle can be realized, for example, by a class in an object-oriented program.

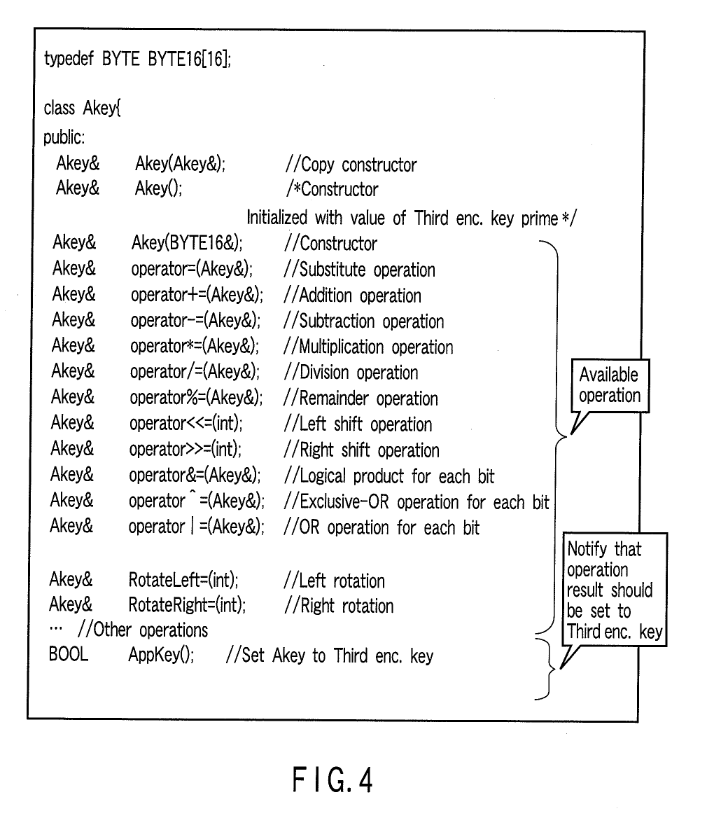

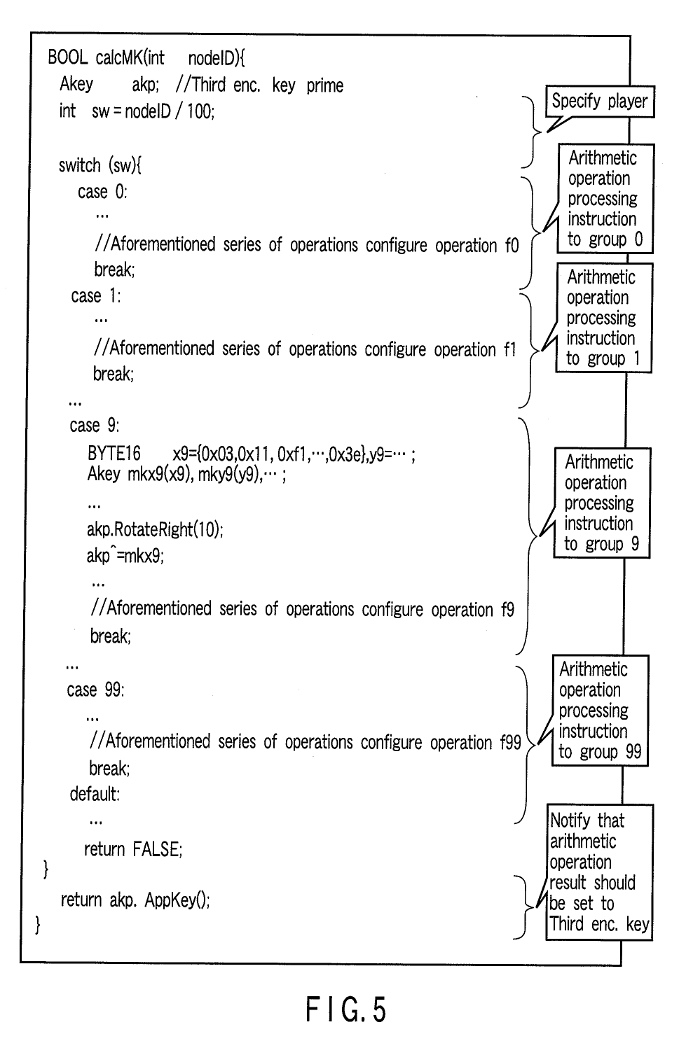

FIG. 4 shows examples of the class for realizing this handle. In FIG. 4, the class (class AKey) is described in the C++ language.

A 16-byte numerical value is stored in “class AKey”, but “class AKey” is not provided with any means permitting the script 102 to read the particular numerical value. Nevertheless, “class AKey” has plural member functions to perform various arithmetic operations on the particular numerical value, including substitution, addition, subtraction, multiplication, division, remainder calculation, left shift operation, right shift operation, logical product operation in bits, exclusive-OR operation in bits, OR operation in bits, left rotation and right rotation. By combining these member functions, the script 102 can designate, to the operation processing unit 202, the operation f to be executed by combining these member functions.

Incidentally, the operation f to be executed, i.e. the content of the arithmetic operation to be executed is not necessarily sent out to the content protection module 13 from the script 102. For example, only the ID information for identifying the operation f to be executed may be sent out from the script 102 to the content protection module 13. In this case, the operation processing unit 202 of the content protection module 13 specifies, for the third encryption key prime, the operation process to be executed in accordance with the ID information, and executes the specified arithmetic operation on the first encryption key prime/third encryption key prime. As a result, the content of the arithmetic operation to be executed on the first encryption key prime/third encryption key prime, i.e. the content of the operation f can be formed as a global secret for an improved safety.

The script 102 accesses “class AKey” and, using the member function defined in “class AKey”, instructs the operation processing unit 202 to execute the operation f on the AKey variable initialized by the value of the third encryption key prime. After that, the script 102 accesses the AppKey ( ) method. This method notifies the content protection module 13 that the present value of the MKey variable is the first encryption key/third encryption key. The operation processing unit 202, in response to this notification sent out from the script 102 after the instruction on the arithmetic operation, finally determines the operation result for the first encryption key prime/third encryption key prime, i.e. the present value of the AKey variable as a first encryption key/third encryption key. In other words, by using the present value of the AKey variable as a first encryption key/third encryption key in response to the notification described above, the process of decrypting the content encryption key file is started. The operation f is a combination of various arithmetic operations, and therefore, the operation processing unit 202 can correctly determine, based on the notification described above, that the arithmetic operation on the first encryption key prime/third encryption key prime is completed.

As described above, the value of the first encryption key prime/third encryption key prime and the procedure for operating the first encryption key prime/third encryption key prime are encapsulated, so that the script 102 cannot manipulate the value of the first encryption key prime/third encryption key prime directly but only through the function in “class AKey”.

Next, an example of the script 102 will be explained.

As described above, the script 102 first accesses “class AKey”, and determines the player group including the player 10. Then, the script 102 sends out an instruction to the content protection module 13 to execute the operation f , as the arithmetic operation, corresponding to the player group including the player 10. The script 102 accesses AppKey ( ) method and notifies the content protection module 13 that the present value of the AKey variable is the first encryption key/third encryption key.

FIG. 5 shows an example of the description of the script 102.

An example of the description of the script 102 in the C++ language is shown in FIG. 5. The script 102 contains the function (SW=node ID/100) for identifying the player group including the player 10. This function determines which one of 1, 2, 3, . . . , 99 is the value (quotient) obtained by dividing the node ID by 100, for example. The quotients 0, 1, 2, 3, . . . , 99 each indicate the player group. Also, the script 102 contains the description of the operations f0, f1, f2, f3, . . . , f99 as the arithmetic operation instructions corresponding to the player groups 0, 1, 2, 3, . . . , 99, respectively. The operations f0, f1, f2, f3, . . . , f99 may be either the very description of the actual arithmetic operation to be executed or, as described above, the description of the ID information for identifying the operation process to be executed. The use of this ID information makes it possible to conceal the nature of the operation f from outside and the first encryption key/third encryption key can be protected more safely.

Further, the script 102 contains the description of the code (return mkp.AppKey ( );) for accessing the AppKey ( ) method and notifying the content protection module 13 that the present value of the AKey variable is the first encryption key/third encryption key.

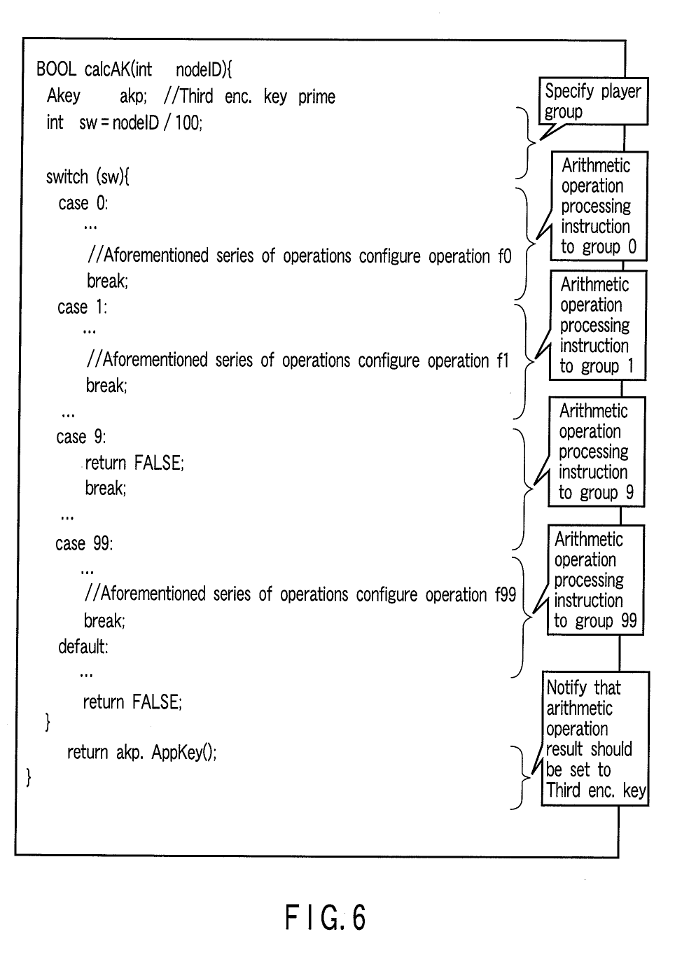

Now, assume that the studio revokes the players having the node ID/100 equal to 9, i.e. the players included in the player group 9. In this case, the studio records the script 102 shown in FIG. 6 in the optical disk medium 100.

The script 102 shown in FIG. 6 contains no description of the operation processing instruction corresponding to the player group 9. As long as the player with the optical disk medium 100 inserted therein is included in the player group 9, therefore, the script 102 does not give the correct operation processing instruction (f9) to the operation processing unit 202 of the content protection module 13. As a result, each player associated with the player group 9 cannot calculate the correct first encryption key/third encryption key, with the result that the content 101 stored in the optical disk medium 100 cannot be correctly reproduced. In the case where the node ID of the player 10 as shown in FIG. 3 is 905, for example, the player 10 belongs to the player group 9. Therefore, the script 102 fails to give the correct operation processing instruction (f9) to the operation processing unit 202 of the content protection module 13.

Incidentally, instead of giving no operation processing instruction to the player group 9 to be revoked, an erroneous operation different from the correct operation f9 may be described in the script 102 as an operation processing instruction corresponding to the player group 9.

Also, instead of specifying a player group based on the value obtained by dividing the node ID by 100, the players may be classified into groups by maker using the maker ID of each maker, etc.

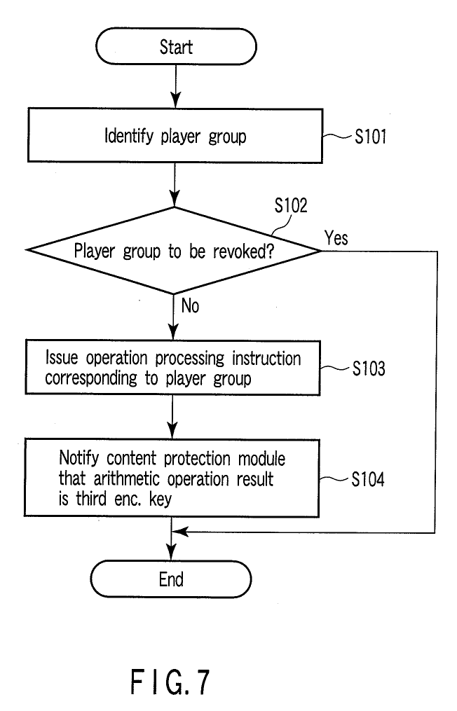

Next, an example of the processing steps executed by the script 102 will be explained with reference to the flowchart of FIG. 7.

The processor such as the CPU arranged in the player 10 executes the script 102 on the script engine 14. The script 102 is started on the script engine 14 and executes the process described below.

The script 102 first accesses “class AKey” and identifies the player group including the player 10 (block S101). In block S101, the script 102 executes, for example, the process of dividing the node ID of the player 10 by 100. Next, the script 102 selects the operation processing instruction (operation) corresponding to the player group including the player 10 from among the plural operation processing instructions (operations) described in the script 102. In the case where the operation processing instruction corresponding to the player group including the player 10 is not described in the script 102, for example, the player group including the player 10 is determined the one to be revoked (YES in block S102). In this case, the process is ended without sending the operation processing instruction from the script 102 to the content protection module 13.

In the case where the operation processing instruction corresponding to the player group including the player 10 is described in the script 102, i.e. in the case where the player group including the player 10 is not to be revoked (NO in block S102), on the other hand, the operation processing instruction corresponding to the player group including the player 10 is sent out to the content protection module 13 from the script 102 through the script engine 14 (block S103). After that, the script 102 accesses the AppKey ( ) method, and notifies the content protection module 13 that the present value of the AKey variable is the first encryption key/third encryption key (block S104).

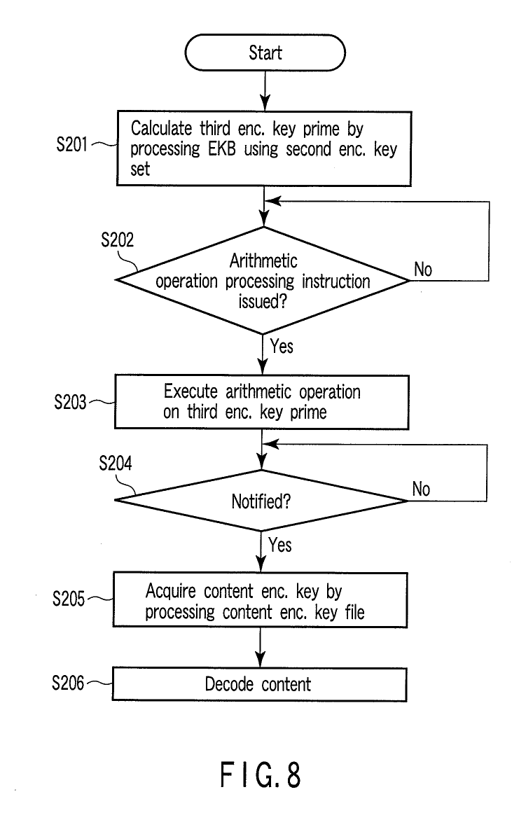

Next, a series of processing steps executed by the content protection module 13 will be explained with reference to the flowchart of FIG. 8.

The content protection module 13 processes the encryption key block 103 through the second encryption key set stored in the player 10 thereby to calculate the third encryption key prime unique to the player 10 or the player group including the player 10 (block S201). Then, the content protection module 13 waits for the operation processing instruction sent from the script 102.

Upon receipt of the operation processing instruction sent from the script 102 through the script engine 14, the content protection module 13, in accordance with the operation processing instruction thus received, executes the arithmetic operation on the third encryption key prime while at the same time concealing the value of and the result of the arithmetic operation on the third encryption key prime from the script 102 and the script engine 14 (block S203). Then, the content protection module 13 waits for the notification from the script 102 that the result of the arithmetic operation on the third encryption key prime is the third encryption key (block S204).

Upon receipt of this notification through the script engine 14, the content protection module 13 finally determines the result of the arithmetic operation on the third encryption key prime as an third encryption key and processes the content encryption key file 104 with the particular third encryption key thereby to acquire the content encryption key from the content encryption key file 104 (block S205). Then, the content protection module 13 decrypts the content 101 with the acquired content encryption key (block S206).

Incidentally, the process of block S205 may be automatically started in response to the end of execution of the arithmetic operation without waiting for the notification described above.

In the new encryption key block process, the new decrypting process is defined as shown in FIG. 8 by addition to the content decrypting process defined by the existing content protection standard. In the case where this added process is applied simply to the starting sequence of the existing HD DVD-Video standard/content protection standard, however, the existing standard and implementation are considerably changed failing to meet the practical requirements. In simple application of the process shown in FIG. 8 to the starting sequence of the existing HD DVD-Video standard/content protection standard, the first step is to determine whether the device is compatible with the new encryption key block process, and in the case where the device is so compatible, the new encryption key block process is executed as shown in FIG. 8. Then, it may be considered that the third encryption key is determined from the third encryption key prime (pre-navigation process), the content encryption key is decrypted with the third encryption key, and the script decrypted by the content encryption key (for example, sniffing) is executed, after which the first playlist is read. In the processing flow according to the HD DVD-Video standard, however, the first step of the starting sequence is to analyze the playlist. Any change of the flow to permit the execution of any script (the script for determining the legacy or new encryption key block, the pre-navigation script or the sniffer script) before execution of the playlist, therefore, is undesirably accompanied by a considerable change in the existing standard and implementation.

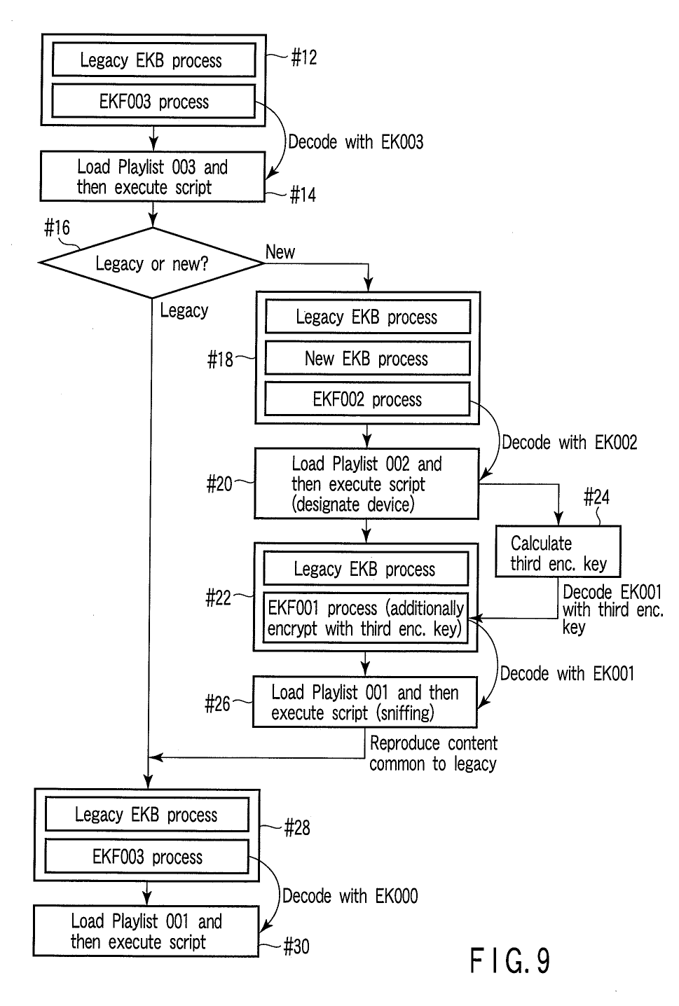

In view of this, this embodiment provides an implementation method for the new encryption key block process which suppresses the change in the existing HD DVD-Video standard/content protection standard. The starting sequence is shown in FIG. 9.

In the case under consideration, there are four playlists (with four content encryption key files). In the content encryption key files EKF000, EKF002 and EKF003, the content encryption key is encrypted by the first encryption key, while in the content encryption key file EKF001, the content encryption key is encrypted by the third encryption key. The playlist file name is VPLST%%% or APLST%%%, where “%%%” is an arbitrary number of 000 to 999. In the starting sequence, the playlist of the maximum number is first read. In block #12, therefore, the file related to the content protection associated with playlist 003 is processed. In this case, the legacy encryption key block process is executed. Specifically, the first encryption key prime is generated by processing the encryption key block 103 with the second encryption key set stored in the player 10 thereby to generate the first encryption key. As a result, the content encryption key file EKF003 is decrypted and the content encryption key EK003 is generated. Playlist 003 is read in block #14, and the script decrypted with the content encryption key EK003 is executed. This script determines whether the reproduction apparatus is a new one compatible with the new encryption key block process or a legacy one not compatible with the new encryption key block process (block #16).

Upon determination that the reproduction apparatus is a legacy one, the process directly jumps to the playlist for reproducing the main part of the content but not to the playlist for executing the new encryption key block process.

Upon determination that the reproduction apparatus is a new one, on the other hand, the process proceeds to the playlist for executing the script for extracting the third encryption key. In block #18, the file related to the content protection associated with playlist 002 is processed. In this case, the legacy encryption key block (EKB) process and the new encryption key block (EKB) process are executed. The file name that can be designated in the legacy encryption key block process is not only the encryption key block ROM but includes EKB001. In this case, different first encryption keys are generated. The first encryption key is generated by the legacy first encryption key block process, so that the content encryption key file EKF002 is decrypted and the content encryption key EK002 is generated. The third encryption key prime is generated by the new first encryption key block process.

In block #20, playlist 002 is read, and the script decrypted by the content encryption key EK002 is executed. The second encryption key assigned for each reproduction apparatus is accompanied by the corresponding information called the device node. Using this information (i.e., device node), the script process is branched. The value of the third encryption key prime varies depending on the second encryption key. By acquiring the value of the second encryption key during the script process, therefore, the process corresponding to the particular value (software key conversion function process) is executed thereby to extract the third encryption key not dependent on the device. This script calculates the third encryption key from the third encryption key prime (block #24).

After reading playlist 002, the file related to the content protection associated with playlist 001 is processed in block #22. In this block, the legacy encryption key block process is executed. The content encryption key EKF001 is decrypted by the third encryption key calculated in block #24 thereby to generate the content encryption key EK001. In block #26, playlist 001 is read, and the script decrypted with the content encryption key EK001 is executed. This script determines the legitimacy of the device such as the virus scan (for example, sniffing), and once the legitimacy is confirmed, the process jumps to the playlist for reproducing the main part of the content. In block #28, the file related to the content protection associated with playlist 000 is processed. In this case, the legacy encryption key block process is executed, the first encryption key is generated, and the content encryption key file EKF000 is thereby decrypted by the first encryption key, and the content encryption key EK000 is generated. In block #30, playlist 000 is read, and the script decrypted with the content encryption key EK000 is executed.

As described above and as shown in the flowchart of FIG. 9, the starting sequence according to this embodiment is different only in that the new encryption key block (EKB) process is added in block #18, that block #24 for generating the third encryption key is added and that the content encryption key file is decrypted not by the first encryption key but by the third encryption key in block #22. The other points remain unchanged from the existing HD DVD-Video standard and the existing content protection standard. In the sequence shown in FIG. 9, the change can be minimized by encrypting the content encryption key with the third encryption key.

According to this embodiment, as described above, the extraction of the correct third encryption key by the content protection module 13 can be permitted or prohibited under the control of the script 102. The script 102 can be provided independently by the studio. Even during the period before the encryption key block 103 is updated, therefore, the control operation for permitting or prohibiting the reproduction of the content 101 such as the video title can be flexibly performed by the independent determination of the studio. As a result, the studio can revoke a specific player or player group in it own.

In the case where it is desired to create the content not executable without extracting the third encryption key correctly, the use of the third encryption key itself for encryption is accompanied by a large alteration of the existing HD DVD-Video standard and the existing content protection standard resulting in a high implementation load. In view of the fact that the third encryption key is used for additionally encrypting the content encryption key for encrypting the content, however, the process for decrypting the content is not required to be changed, and therefore, the change in the standards and the increase in implementation load can be suppressed.

Also, the fact that the content encryption key file contains the flag USE_APP_KEY indicating the additional encryption with the third encryption key contributes to the suppression of the change in the standards and the increase in implementation load. In the content protection standard, the file name of the content encryption key file is determined following the playlist name. To determine encryption or no encryption by the third encryption key according to the file name, therefore, involves a large change in both the standards and implementation. In the method of newly adding, to the existing content encryption key file, a field indicating the presence or absence of encryption with the third encryption key, on the other hand, the decrypting process with the third encryption key can be concealed in the internal process of the content encryption key file, and therefore, the change in standards and implementation can be suppressed.

Also, in the arithmetic operation on the third encryption key prime, the content protection module 13 does not deliver the third encryption key prime to the script 102. Instead, in accordance with the operation processing instruction from the script 102, the arithmetic operation is executed on the third encryption key prime stored in the content protection module 13. As a result, the value of the third encryption key prime and the value of the arithmetic operation result can be concealed from the script 102. Thus, the function of the script 102 controlling the extraction of the third encryption key by the content protection module 13 can be safely executed.

Incidentally, once the script 102 shown in FIG. 5 is read by the hacker, the nature of the operation f9 in “case 9”, for example, is known to the hacker. In order to prevent this inconvenience, the script 102 may be encrypted and stored in the optical disk medium 100. Also, as described above, the nature of the operation f is not described in the script 102 directly, but the ID information for identifying the operation f (for example, ID of the operation f ) may be described effectively in the script 102.

Further, in order to prevent the illegal alteration of the script 102, the anti-alteration means may be included in the script 102 and the script 102 having the anti-alteration means may be stored in the optical disk medium 100. In an anti-alteration method to be used, the hash value of the script 102 is calculated and stored in the content hash table in the optical disk medium 100. The content protection module 13 first calculates the hash value of the script 102, and in accordance with whether the calculated hash value coincides with the hash value stored in the content hash table, the legitimacy of the script 102 can be determined.

The script engine 14 has no tamper-resistant construction. Once the content of the operation f9 is known to the hacker, therefore, the hacker can issue the instruction to execute the correct operation f9 to the content protection module 13 from the script engine 14 by controlling the script engine 14 even if the player 10 is revoked by the script 102, and thus can extract the third encryption key. In the case where the encryption key block 103 is updated and the third encryption key prime is changed, however, the content of the operation f9 is also changed, and therefore, the hacker cannot extract the correct third encryption key.

Incidentally, the functions of the player 10 shown in FIG. 1 can be all realized by the computer program. Simply by introducing this computer program to a normal computer through a computer-readable storage medium, therefore, the normal computer can be rendered to function as the player 10 (software player).

According to the embodiment of the invention, even during the period before the first encryption key block is updated, the control operation for permitting or prohibiting the reproduction of the digital content such as the video title can be carried out safely and flexibly.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions. The various modules of the systems described herein can be implemented as software applications, hardware and/or software modules, or components on one or more computers, such as servers. While the various modules are illustrated separately, they may share some or all of the same underlying logic or code.

What is claimed is:

1. A reproduction apparatus for reproducing an encrypted digital content stored in a storage medium, comprising:
a program execution module configured to execute a program stored in the storage medium; and
a processing module;
wherein the processing module comprises:
a calculation module configured to calculate a third encryption key prime by processing a content encryption key block stored in the storage medium using a second encryption key set of the reproduction apparatus, the third encryption key prime being unique to the reproduction apparatus or a reproduction apparatus group comprising the reproduction apparatus, and a third encryption key which can decrypt the content encryption key file stored in the storage medium being obtained by subjecting the third encryption key prime to an arithmetic operation;
an arithmetic module configured to execute the arithmetic operation on the third encryption key prime in accordance with an operation processing instruction for the third encryption key prime sent from the program through the program execution module, while the third encryption key prime and a result of the arithmetic operation are concealed from the program and the program execution module; and
an execution module configured to decrypt the content encryption key file by use of a result of the arithmetic operation on the third encryption key prime as the third encryption key, and wherein the processing module is configured to decrypt the content encryption key file related to a playlist for each load of the playlist.

2. The reproduction apparatus of claim 1, wherein
the processing module further comprises a first encryption key calculation module configured to calculate a first encryption key by processing the encryption key block stored in the storage medium by the second encryption key set of the reproduction apparatus, the first encryption key being unique to the reproduction apparatus or a reproduction apparatus group including the reproduction apparatus, and the content encryption key file stored in the storage medium being able to be decrypted by a value obtained by subjecting the first encryption key to the arithmetic operation, and
the content encryption key file stored in the storage medium comprises a flag indicating whether the content encryption key file is encrypted by the third encryption key or by the first encryption key.

3. The reproduction apparatus of claim 1, wherein
the program comprises description of different operation processing instructions corresponding to each of reproduction apparatus groups or each of reproduction apparatuses, and
the program is configured to identify the reproduction apparatus or a reproduction apparatus group comprising the reproduction apparatus, to select one of the operation processing instructions corresponding to the reproduction apparatus or the reproduction apparatus group comprising the reproduction apparatus, and to send the selected one of the operation processing instructions corresponding to the reproduction apparatus or the reproduction apparatus group comprising the reproduction apparatus to the processing module through the program execution module.

4. The reproduction apparatus of claim 3, wherein
the operation processing instruction is identification information for identifying the arithmetic operation for obtaining the third encryption key from the third encryption key prime which is unique to the reproduction apparatus or the reproduction apparatus group comprising the reproduction apparatus, and
the arithmetic module is configured to specify the arithmetic operation to be executed on the third encryption key prime in accordance with the identification information, and to execute the specified arithmetic operation on the third encryption key prime.

5. The reproduction apparatus of claim 1, wherein the arithmetic module is configured to establish a result of the arithmetic operation on the third encryption key prime as the third encryption key in response to a notification which is sent from the program through the program execution module after the operation processing instruction is issued, indicating that the result of the arithmetic operation on the third encryption key prime is the third encryption key.

6. A reproduction method for decrypting an encrypted digital content stored in a storage medium, by a processing module having a tamper-resistant structure and arranged in a reproduction apparatus, the method comprising:
calculating a third encryption key prime by processing a content encryption key block stored in the storage medium using a second encryption key set of the reproduction apparatus, the third encryption key prime being unique to the reproduction apparatus or a reproduction apparatus group comprising the reproduction apparatus, and a third encryption key which can decrypt a content encryption key file stored in the storage medium being obtained by subjecting the third encryption key prime to an arithmetic operation;
executing a program stored in the storage medium;
executing the arithmetic operation on the third encryption key prime in accordance with an operation processing instruction for the third encryption key prime sent from the program, while the third encryption key prime and a result of the arithmetic operation are concealed from the program; and
decrypting the content encryption key file related to a playlist by use of the result of the arithmetic operation on the third encryption key prime as the third encryption key for each load of the playlist.

7. The reproduction method of claim 6, further comprising:
processing the content encryption key block stored in the storage medium by the second encryption key set of the reproduction apparatus; and
calculating a first encryption key which unique to the reproduction apparatus or a reproduction apparatus group comprising the reproduction apparatus, and the content encryption key file stored in the storage medium being able to be decrypted by a value obtained by subjecting the first encryption key to the arithmetic operation,
wherein the content encryption key file stored in the storage medium comprises a flag indicating whether the content encryption key file is encrypted by the third encryption key or by the first encryption key.

8. The reproduction method of claim 6,
wherein the program comprises description of different operation processing instructions corresponding to each of reproduction apparatus groups or each of reproduction apparatuses, and
the executing the program comprises:
identifying the reproduction apparatus or a reproduction apparatus group comprising the reproduction apparatus;
selecting one of the operation processing instructions corresponding to the reproduction apparatus or the reproduction apparatus group comprising the reproduction apparatus; and
sending the selected operation processing instruction corresponding to the reproduction apparatus or the reproduction apparatus group comprising the reproduction apparatus to the processing module through the program execution module.

9. The reproduction method of claim 8, wherein
the operation processing instruction is identification information for identifying the arithmetic operation for obtaining the third encryption key from the third encryption key prime which is unique to the reproduction apparatus or the reproduction apparatus group comprising the reproduction apparatus, and
the arithmetic operation executing comprises specifying the arithmetic operation to be executed on the third encryption key prime in accordance with the identification information, and executing the specified arithmetic operation on the third encryption key prime.

10. The reproduction method of claim 6, wherein the arithmetic operation executing comprises establishing a result of the arithmetic operation on the third encryption key prime as the third encryption key in response to a notification sent from the program through the program execution module after the operation processing instruction is issued, indicating that the result of the arithmetic operation on the third encryption key prime is the third encryption key.

11. An information storage medium comprises:
a content encrypted by a content encryption key;
a content encryption key file encrypted by one of a first encryption key and third encryption key;
an encryption key block from which a third encryption key prime providing a source of generating the first encryption key or third encryption key by being processed by using a second encryption key of a reproduction apparatus; and
a program configured to make the reproduction apparatus calculate the third encryption key from the third encryption key prime,
wherein the content encryption key file comprises a flag indicating whether the content encryption key file is encrypted by the third encryption key or by the first encryption key.
